(19) United States
(12) Patent Application Publication
(10) Pub. No.: US 2023/0368794 A1
(43) Pub. Date: Nov. 16, 2023

(54) VOCAL RECORDING AND RE-CREATION

(71) Applicant: Sony Interactive Entertainment Inc., Tokyo (JP)

(72) Inventor: Sarah Karp, San Mateo, CA (US)

(21) Appl. No.: 17/744,138

(22) Filed: May 13, 2022

(51) Int. Cl. G10L 15/26; G10L 15/22; G10L 25/63

(52) U.S. Cl. CPC G10L 15/26; G10L 15/22; G10L 25/63; G10L 2015/223

(57) ABSTRACT

Methods and systems for recreating audio include recording an audio generated by a user at a first device. The audio is processed to convert speech to text and to identify one or more characteristics of the audio capturing emotion and verbal expression of the user. Data packets are generated by compressing the text and the one or more characteristics for transmission to a second device. The text and metadata included in the data packets are used to re-create the audio at the second device.

### TECHNICAL FIELD

The present disclosure relates to capturing and rendering audio and more particularly to capturing emotions and intent expressed in the audio at a first device and automatically reproducing the audio with the emotions and intent at a second device.

### BACKGROUND OF THE DISCLOSURE

Communicating over the Internet has become main stream. With the amount of interactive applications available and the amount of interactive data exchanged amongst users and between users and interactive applications, quality of content (e.g., quality of audio) is very crucial. Particularly, when the users are accessing the interactive application from different geo locations or are communicating with other users over a network, such as the Internet, the quality of content can hugely vary depending on the state of one's remote communication facilities (computer, wi-fi connection, etc.,). For example, depending on the state of the communication facilities used by the users, the voice quality can vary widely. From voices that sound like they are underwater to voices that are too sharp and loud, it is very hard to find the right balance to hear others online.

To alleviate such distortion, speech-to-text engines are employed to transcribe the speech uttered by users into text. However, existing speech-to-text engines can recreate the words someone may say but miss out on the emotion and intent behind the words uttered by the users. Subtle hints like sarcasm or excitement are hard to convey. Further, the speech-to-text engines sometimes are unable to decipher all the text due to the speed in which the words are uttered or due to language barriers or due to different accents.

It is in this context that embodiments of the disclosure arise.

### SUMMARY

Implementations of the present disclosure relate to systems and methods for capturing audio locally at a first device, convert the audio to text, analyze the audio to determine one or more characteristics of the audio, store the one or more characteristics of the audio with the text as metadata, compress the text and the metadata into data packets and transmit the data packets over a network, such as the Internet, to a second device. The one or more characteristics that are determined from the audio can include pitch, volume, pacing, spacing, tone, etc., of the user. These characteristics can be used to determine the emotion and intent of the user generating the audio. The data packets transmitted to the second device are decompressed and the text and the metadata contained in the data packets are used to recreate the audio for rendering at the second device. The recreated audio not only provides the text of the audio but also substantially mimics the emotion and intent of the user captured at the first device.

The audio generated at the first device is an analog signal, which is converted into digital format and transmitted to the second device. The metadata representing the one or more characteristics of the text of the audio is similar in size as the text, which is substantially smaller than the analog signal. As a result, the size of the data packets that represent the digital format of the audio is much smaller, resulting in substantial reduction of the file size transmitted over the network to the second device. The characteristics assist in re-creating the audio at the second device. The re-created audio rendered at the second device is a more accurate representation of the emotion and intent of the user expressed in the audio generated at the first device.

In one implementation, a method for recreating audio is disclosed. The method includes recording an audio generated by a user at a first device. The audio of the user is processed to convert speech to text and to identify one or more characteristics capturing emotion and verbal expression (i.e., intent) of the user. The one or more characteristics define metadata of the audio. The text and the metadata are packetized into data packets for transmission over a network to a second device for rendering. The second device is remotely located from the first device. The text and metadata included in the data packets are used to re-create the audio at the second device. The re-created audio replicates the emotion and verbal expressions expressed by the user at the first device.

In one implementation, a system for recreating audio is disclosed. The system includes a first device used to capture audio spoken of a user. The first device is coupled to a first codec. The first codec is configured to record the audio spoken by the user at the first device, process the audio to convert speech to text and to identify one or more characteristics capturing emotion and verbal expression of the user captured in the audio. The one or more characteristics define metadata of the audio. The first codec is further configured to generate data packets using the text and the metadata identified for the audio. The data packets are generated by compressing the text and the metadata of the audio for transmission to a second device for rendering. The second device is located remotely from the first device. The second device is coupled to a second codec. The second codec is configured to decompress the data packets to extract the text and the metadata included therein. The text and the metadata are used to re-create the audio of the user for rendering at the second device. The re-created audio replicating the emotion and verbal expressions expressed by the user generated at the first device.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings.

FIG. 1A illustrates a simplified data flow diagram used for processing audio generated by a first user at a first device and transmitting the processed data to a second device for rendering, in accordance with one implementation of the present disclosure.

FIG. 1B illustrates a simplified data flow diagram of processing audio generated by a first user at a first device and transmitting the processed data to a second device for rendering, in accordance to an alternate implementation of the present disclosure.

FIG. 2 illustrates a simplified block diagram of a coder-decoder (Codec) coupled to a first device and used for processing audio generated by a first user at a first device, in accordance with one implementation of the present disclosure.

FIG. 3A illustrates a sample table identifying various characteristics of audio used to define metadata of the audio, in accordance with one implementation of the present disclosure.

FIG. 3B illustrates a sample table identifying various characteristics of audio used to define metadata of the audio, in accordance with an alternate implementation of the present disclosure.

FIG. 4 illustrate flow of operations of a method for generating data packets of audio transmitted from a first computing device to a second computing device, in one implementation of the present disclosure.

FIG. 5 illustrates components of an example computing device that can be used to perform aspects of the various implementations of the present disclosure.

### DETAILED DESCRIPTION

In the following description, numerous specific details are set forth in order to provide a thorough understanding of the present disclosure. It will be apparent, however, to one skilled in the art that the present disclosure may be practiced without some or all of these specific details. In other instances, well known process steps have not been described in detail in order not to obscure the present disclosure.

As portability and gaming anywhere becomes mainstream and important, so does the audio experience. Depending on the communication facilities used by a user for communicating with other users and interactive applications, audio quality varies widely. For instance, based on the communication facilities of the user, the audio generated by the user can sound like they are underwater (e.g., muffled audio), or clear and crisp (e.g., loud and sharp), or near and clear (e.g., sound normal and local). To mitigate variation in the audio quality, speech-to-text engines are employed to transcribe the speech to text. However, the conversion to text using the speech-to-text engines misses on the emotion and intent of the user. For example, subtle hints like sarcasm or excited utterance or frustration are very difficult to convey in the text.

In order to correctly capture the emotion and intent (i.e., verbal expression) in the audio generated by the user, a system is proposed. The system is configured to record the audio locally, save the audio as text, determine the one or more characteristics of the audio, transmit the text and the one or more characteristics of the audio to a second device over a network, such as the Internet. The one or more characteristics are defined as metadata of the audio. The text and the metadata of the audio are used to reconstruct the audio at the second device. The reconstructed audio closely mimics the emotion and the intent included in the audio of the user captured at the first device.

The quality of the voice reconstruction using the text and the metadata is much more legible and understandable than the quality of live audio recordings, irrespective of the quality of internet connection. The reconstructed audio is more human sounding than the robot-sounding audio generated by the speech-to-text engines. Further, the text and metadata of the audio is transmitted as digital data. As a result, the amount of data (i.e., audio data) transmitted in digital format (i.e., in text and metadata) is far less than the amount of data sent for the audio as an analog signal. Further, the reconstructed audio has much more clarity than the analog signal as the ambient noise is significantly reduced when the audio is transmitted as text and the metadata than when transmitted as an analog signal. In high-stakes game, a user (e.g., player, spectator) wants to avoid unwanted noise and get clear direct communications from their team-mates or other spectators in their group. The metadata recording the personal traits of the user allows reconstruction of the audio using minimal transmission of data over uncertain networks and data loss. Reconstruction of the audio using the text and the metadata of the audio captured at the first device allows for clear direct communications between the player and their team-mates. The recreated audio with personalized characteristics of the user provides the intimacy and personability without loss of clarity, as the reconstructed audio rendered at the second device closely mimics the user's emotion and intent provided at the first device.

With the general understanding of the disclosure, specific details will be described with reference to the various drawings.

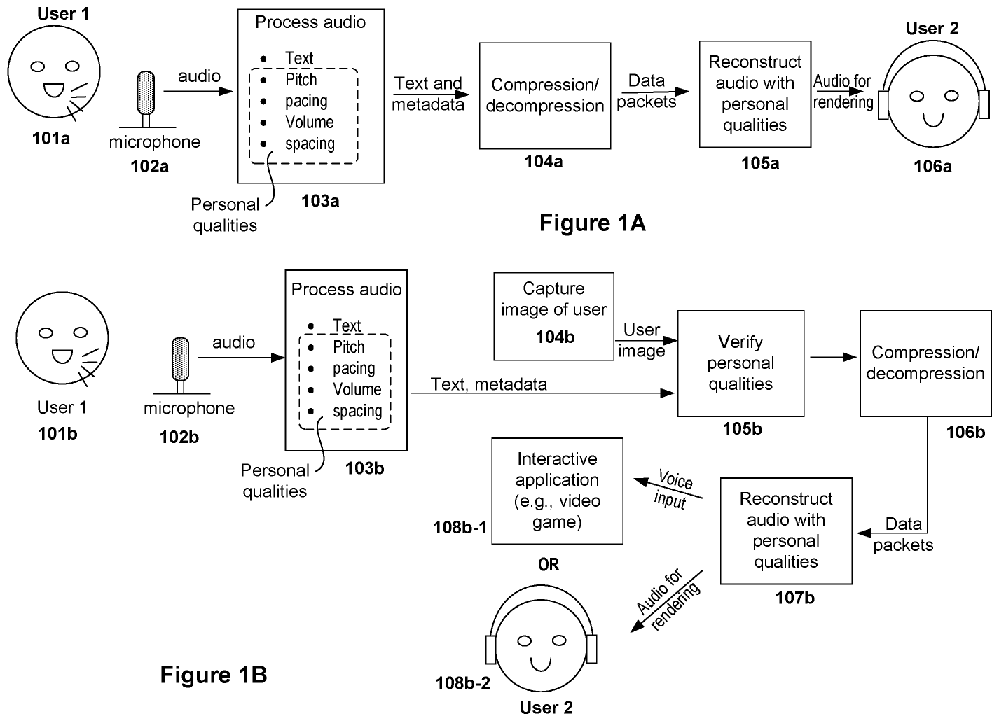

FIG. 1A shows an example data flow of processing audio generated at a first device and transmitting the processed audio to a second device for recreating the audio, in one implementation. Audio generated by a user 101a is recorded by a microphone 102a of a first device. The first device can be a computing device, such as a desktop computing device, laptop computing device, mobile computing device, etc. The audio can be voice input to an interactive application, a chat input to a chat application, an interaction between the user as a player with other players or spectators of a video game, an interaction between the user as a spectator with players or other spectators of the video game, etc. The audio generated by the user is processed (103a) and stored at a first device (not shown). The processing of the audio (103a) includes speech-to-text conversion of the audio using a speech-to-text engine available to the first device. The processing further includes analyzing the audio to determine one or more characteristics of the audio. The characteristics define personal qualities of the user, such as tone, volume, pacing, pitch, etc. These personal qualities of the user captured from the audio define the emotion and intent of the user when uttering the words captured in the audio.

The representative characteristics of the user expressed in the audio are stored as metadata with the corresponding text of the audio. The text and stored metadata is compressed 104a using a first compression/decompression device (codec) available to the first device, to generate data packets. The first codec is a separate device that is coupled to the first device or is a software module with a set of program instructions that are stored in a memory of the first device and extracted and executed by a processor of the first device. The program instructions are configured to perform the compression/decompression of the data. In some implementations, the codec device is a standard codec device that is available widely. In alternate implementations, the codec device is specifically designed for performing the compression and/or decompression of the data.

The data packets generated by the codec available to the first device are transmitted to a second device over a network, such as an Internet. The second device can be a computing device, such as a desktop computing device, laptop computing device, mobile computing device (e.g., mobile phone, tablet computing device, head mounted display, wearable computing device, etc.), or can be a server, such as a remote server, cloud server, game console, etc. The second device is configured to execute an interactive application and the audio generated at the first device can be provided as an input to the interactive application. For example, the interactive application can be a video game played between a first user of the first device and a second user of the second device. The audio generated by the first user at the first device can be a game input (e.g., voice command) to the video game or can be a chat input directed toward the second user. In alternate implementation, the video game can be a multi-player video game and the audio of the first user can be a chat communication for posting to a chat interface, or a communication between the user as a player with other players in their team, or between the user as a player/spectator with other players/spectators of the video game, or can be a comment provided by the user as a commentator of the video game.

In response to receiving the data packets, the second device can engage a second codec to decompress the data packets and to reconstruct the audio (105a) using the text and the personal qualities of the user included in the metadata. As with the first codec, the second codec can be any generally available codec device or can be specifically designed for decompression of the data transmitted by the first device. The reconstructed audio is rendered (106a) at the second device of the second user. The second codec is configured to interpret the personal qualities included in the metadata to infuse the emotion and intent of the first user in the reconstructed audio, so that the reconstructed audio closely mimics the emotion and the intent of the first user, when rendered to the second user.

In some implementations, the reconstructed audio is used as voice input to affect a state of the interactive application, or is used to post as a chat on a chat interface rendered alongside video content of a video game, or is transmitted to a second device of a second user as a communication from the first user. The reconstructed audio is clear with reduced ambient noise. The identification and transmission of the characteristics provides a balance between preserving the warmth and tone of the speech with the need for voice and signal clarity. All this is achieved with reduced amount of data being transmitted as the text and the metadata is transmitted in digital format which includes far less data than the audio signal if it was transmitted as an analog signal.

FIG. 1B illustrates an alternate example data flow of processing audio generated at a first device and transmitting the processed audio to a second device for recreating the audio, in an alternate implementation. The data flow of FIG. 1B differs from that of FIG. 1A only with reference to verification of metadata prior to compressing the text and the metadata to generate data packets that are transmitted to a second device for rendering. As a result, audio generated by user 1 (101b) is captured by a microphone or similar device (102b) associated with a first device and stored in the first device. The audio is processed to convert the speech to text using a speech-to-text engine available to the first device, and the personal qualities are identified (103b). The personal qualities identifying the emotion and intent of the user are stored as metadata with the corresponding text. The personal qualities identified from the audio are verified to ensure that the identified personal qualities are indeed correct.

As part of verification, one or more images of facial features of the user are captured using one or more image capturing devices (104b) associated with or coupled to the first device. The images of the user are captured as the user is uttering the speech (i.e., text) of the audio. The facial features captured in the images are then analyzed to determine the emotions expressed by the user as the user is uttering the words. The emotions expressed by the user identified from the images are then compared to the personal qualities (i.e., one or more characteristics) that are used to determine emotion and intent of the user. Upon successful verification (105b) of the emotions expressed in the facial features of the user with the emotion determined from the one or more characteristics, the text and the metadata of the audio is forwarded to a first codec associated with the first device for compressing (106b). If, however, the emotions do not match, additional verification is done by analyzing the personal qualities of the user identified from the audio and determining alternate emotion and intent that match with the expressions expressed in the facial features of the user. The personal qualities that correspond to the alternate emotion and intent are then saved as metadata for the audio and forwarded to the first codec for compression.

The first codec performs the compression of the text and the metadata of the audio (106b) in accordance to communication protocol used in communicating with a second device, to generate data packets. The data packets are then transmitted to the second device for reconstructing the audio (107b) and providing the reconstructed audio as voice input to affect a state of the interactive application (108b-1) executing at the second device or for rendering the reconstructed audio at the second device for the second user (108b-2). A second codec available to the second device is used to decompress the data packets and use the text and metadata to reconstruct the audio, which is rendered at the second device for the second user consumption or to the interactive application executing at the second device.

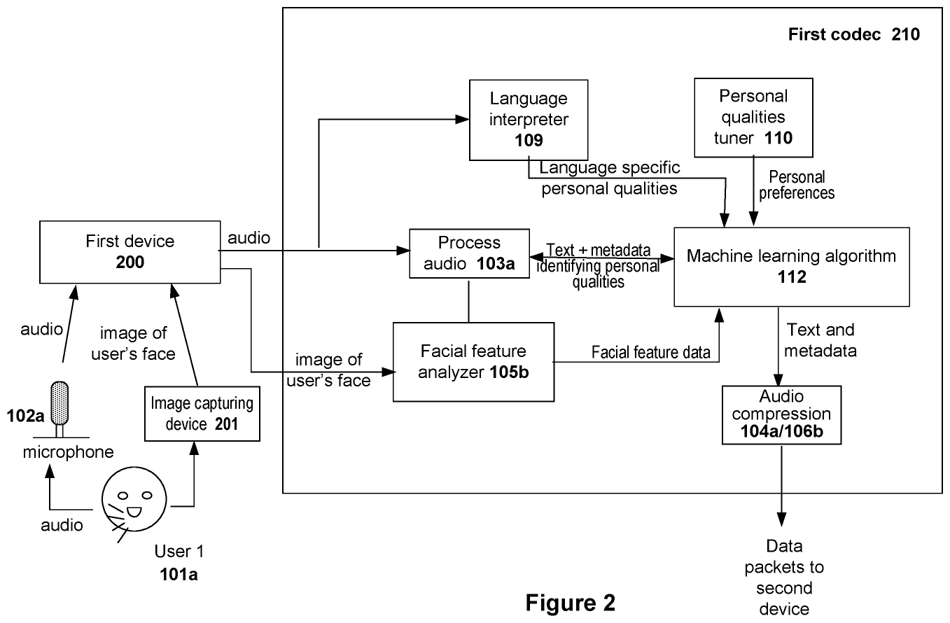

FIG. 2 illustrates some of the modules within a codec (e.g., a first codec associated with a first device) that are configured to process the audio generated by a user at the first device, in one implementation. As noted, the first device 200 receives audio data from user 1 (101a) via a microphone 102a or any other audio receiving device available within or to the first device 200. The first device 200 can be a laptop, desktop, wearable or mobile computing device that is used by user 1 to interact with an interactive application that is executing remotely on a second device. Similarly, the second device can be a laptop, desktop, wearable or mobile computing device or a networked game console or server computing device that is part of a local or wide area network or part of a cloud system, and communicatively connected to the first device. The audio data is received at the first device 200 as an analog signal.

In addition to capturing the audio of user 1, one or more images of user 1 are also captured by one or more image capturing devices 201 during the time user 1 is generating the audio (i.e., speaking). The image capturing device 201 may be part of the first device or can be an independent device that is communicatively coupled to and controlled through signals originating from the first device. The image capturing device(s) 201 are configured to capture facial features of user 1, which can be used to determine the expressions of user 1. The expressions can be interpreted to determine the emotion(s) exhibited by user 1.

The first device 200 forwards the audio and the images of user 1 to a codec 210. The codec 210 can be part of the first device or communicatively coupled to the first device 200. The codec 210 include a process audio module to process the audio signal provided by the first device 200 (103a of FIG. 1A, 103b of FIG. 1B) and a facial feature analyzer module to process the images of user 1 to verify the expressions of user 1 captured as user 1 was speaking (105b of FIG. 1B). In addition to process audio module 103a and facial feature analyzer module 105b, the codec 210 includes a language interpreter module 109, a personal qualities tuner module 110 and machine learning algorithm 112 to process the audio, determine the one or more characteristics of the audio, and verify the one or more characteristics of the audio. The one or more characteristics of the audio define personal qualities of the user captured from the user's voice as the user speaks the words included in the audio. The personal qualities can be used to define the emotion and intent of the user.

The process audio module 103a engages a speech-to-text engine to convert the speech in the audio to text. The speech-to-text engine can be integrated within the process audio module 103a or can be coupled to the process audio module 103a. Additionally, the process audio module 103a includes an analysis engine (not shown) to analyze the audio signal to identify one or more characteristics of the audio generated by the user. The characteristics of the audio can include one or a combination of tone, volume, pacing, spacing of the words, pitch, etc. These characteristics of the audio are used to define the personal qualities of user 1. As noted, the personal qualities can be interpreted to define the emotion and intent of user 1 when they are speaking (i.e., providing the audio). The personal qualities identified from the audio of user 1 along with the text of the audio are provided to a machine learning algorithm 112 as input.

The facial feature analyzer module 105b analyzes the facial features captured in the images of user 1 to determine the expressions of user 1 as they are speaking the words captured in the audio signal. The expressions identified from the facial features are interpreted to determine the emotion of user 1. The expressions and the interpreted emotion of user 1 are also provided to machine learning algorithm 112 as facial feature data.

A language interpreter module 109 is used to determine the language spoken by user 1 in the audio received from the first device. The language spoken by the user can be essential to correctly interpret the audio to determine the personal qualities of a user, as the language spoken can influence how the audio is interpreted to determine the personal qualities of the user. Thus, the language interpreter module 109 determines the language spoken by user 1 in the audio and interprets the audio, based on the spoken language, to identify the personal qualities of user 1. In some implementations, user 1 may speak in a first language, user 2 may speak in a second language, and user 3 may speak in both first and second languages. In these implementations, when the first user wants to converse with just the second user, the personal qualities of user 1 are identified from the audio and used to define the metadata. If, however, user 1 has to converse with the third user, the audio of user 1 is first interpreted to determine the personal qualities expressed by user 1 in the first language. The speech in the audio is then translated to the second language and the personal qualities of user 1 expressed in the first language are then correlated with corresponding personal qualities in the second language. The language specific personal qualities are provided to the machine learning algorithm 112 for further processing. In the above example, the personal qualities identified for the first language and the second language are both provided to the machine learning algorithm 112 as language-specific personal qualities in order to verify that the personal qualities identified in the first language are correctly represented in the second language.

The codec 210 also includes a personal qualities tuner module 110 that is configured to allow a user to provide their preferences on select ones of the personal qualities that can be identified for the audio. In some implementations, each of the personal qualities, such as tone, pitch, volume, pacing, spacing between spoken words, and language can be adjusted using tunable knobs. For example, a user might want to disguise their voice to hide their identity or to project a different persona than their original self or to sound as a native of a foreign country. In some implementations, the user might want to change their persona for a specific interactive application or for each interactive application or when communicating with a specific other user(s). Consequently, a plurality of tunable knobs may be provided as digital knobs on a user interface to allow the user to provide their specific selection for each application. User input at the one or more tunable knobs are used as personal preferences of the user for processing the audio. The tunable knobs can be used to define user specific, language specific, interactive application specific personal preferences.

When the audio is received at the codec (e.g., first codec 210), the personal preferences of user 1, the interactive application for which the audio is provided, the language used in the audio are identified and used to process the audio in order to determine the one or more characteristics. In some implementations, the audio is processed for the interactive application in accordance to the personal preferences of user 1 and the language used by user 1, using a machine learning algorithm 112. The machine learning algorithm 112 uses artificial intelligence to generate a model using the various personal qualities preferences of user 1, language specific personal qualities, and personal qualities identified from the audio and use the model to determine emotion and intent of user 1 expressed when speaking the text captured in the audio. The personal qualities (i.e., characteristics) of the audio vary based on the changes in the text of the speech included in the audio and the model is trained continuously with the changes in the audio received from user 1 and from other users. The trained model is used to identify the emotion and intent of user 1 as user 1 spoke the text included in the audio. The emotion and intent obtained from the model is verified against the facial feature data provided by the facial feature analyzer module 105b.

When the verification is unsuccessful (i.e., if the emotion and intent obtained from the model do not match the emotion/intent determined from the images of user 1), the machine learning algorithm performs additional tuning of the model to determine alternate emotion/intent that is verified against the emotions derived from analyzing the facial features. When the verification is successful, the emotion and intent obtained from the model and the one or more characteristics of the audio that make up the personal qualities of the user are included as metadata and stored with the text of the audio. The metadata and the text are then compressed using the audio compression module (104a of FIGS. 1A and 106b of FIG. 1B) to generate data packets. The generated data packets are transmitted to the second device that is remotely located from the first device, for rendering or further processing. In some implementations, the data packets are streamed to the second device in substantial real-time from the first device during the time user 1 is providing the audio at the first device.

The processed and verified text and metadata identified by the machine learning algorithm 112 is provided as input to the audio compression module (104a of FIG. 1A/106b of FIG. 1B). The audio compression module compresses the text and metadata into data packets in accordance to the communication protocol adopted for communicating with the second device over the network (not shown). The compressed data is forwarded to the second device for rendering to the second user or as voice input to the interactive application executing on the second device.

The data packets with the text and the metadata transmitted from the first device 200 or the first codec 210 is received at the second device. A second codec available at the second device is used to decompress the data packets to obtain the text and the metadata included therein. The metadata and the text are used to reconstruct the audio at the second device. The reconstructed audio rendered at the second device closely mimics the audio of user 1 provided at the first device. The reconstructed audio is rendered via a speaker in the second device for second user's consumption or as voice input to the interactive application executing at the second device. The voice input can be used to affect state of the interactive application, such as video game, to generate game content that is returned to the first and the second devices for rendering. The reconstructed audio is in the language of the second user or the language that is acceptable to the interactive application and includes personal qualities' preferences of user 1. Consequently, when the reconstructed audio is rendered to the second user, the reconstructed audio substantially mimics the emotion and intent expressed by user 1. It is to be noted that the intent is interchangeably referred to as “verbal expression” throughout this application as it relates to the facial expressions exhibited by user 1 as they are speaking.

The audio reconstructed at the second device using the text has reduced ambient noise and is much more legible and understandable even when the internet connection is not of high quality. The reconstructed audio using recorded personal qualities preferences (i.e., personal traits) provide the intimacy and personability of talking to user 1 as though user 1 is co-located with the second user. The reconstruction of the audio is effectuated without loss of clarity and with minimal data transmission over networks that can be unreliable or uncertain and data loss.

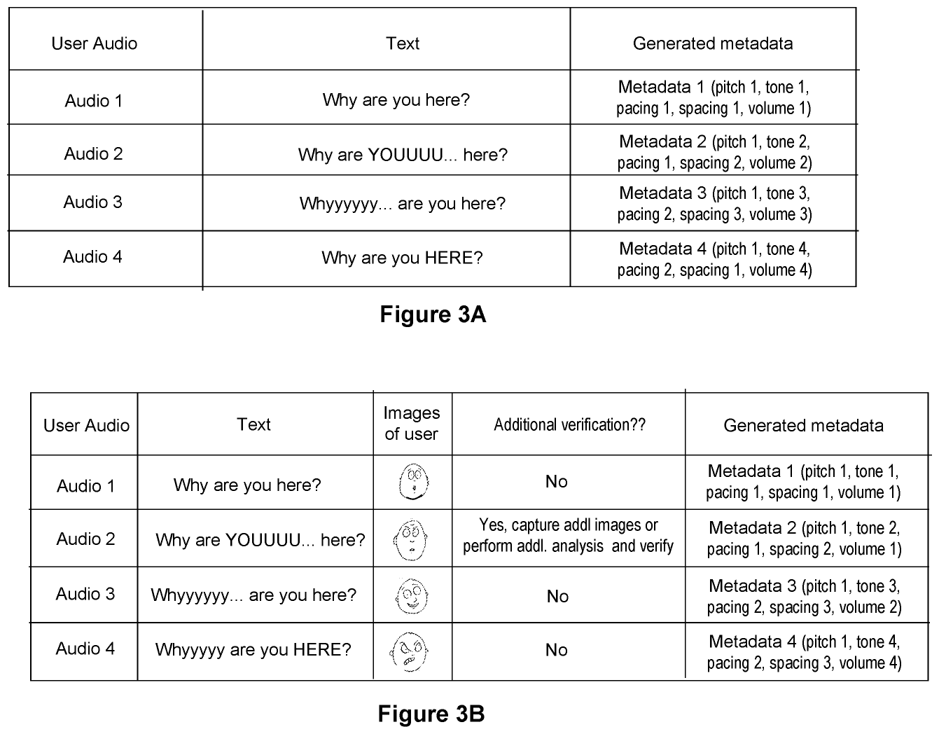

FIG. 3A illustrates different metadata generated for a sample text included in the audio, in some implementations. The audio generated by user 1, for example, when processed using a speech-to-text engine, is noted to include a sample text, “Why are you here?” However, depending on how user 1 has uttered this text can determine the metadata for the text. Thus, as shown in FIG. 3A, the metadata (i.e., metadata 1-4) generated for corresponding the audios 1-4, varies based on the personal qualities identified from the way user 1 has verbally expressed the text. Thus, metadata 1 is generated to include first set of personal qualities (e.g., pitch 1, tone 1, pacing 1, spacing 1, volume 1) identified from the verbal expression of text in audio 1. Similarly, metadata 2 corresponds to a second set of personal qualities identified from the verbal expression of text in audio 2, and so on. As can be seen, the same text included in the audio can be expressed in different ways by varying any one or combination of personal qualities, and such variations included in the verbal expression are detected by the codec 210 to generate different metadata. In some implementations, the codec 210 can be configured and tuned to detect subtle variations in the verbal expressions so that the metadata generated for the audio can capture such subtle variations in the one or more personal qualities identified for the audio. These subtle variations assist during reconstruction of the audio at the second device to closely mimic the audio of user 1.

FIG. 3B illustrates different metadata generated for a sample text included in the audio, in some alternate implementations. In these alternate implementations, the metadata generated to capture the verbal expressions of the sample text are verified against images capturing facial features of user 1 as user 1 is uttering the sample text. FIG. 3B shows the facial features of user 1 captured as images by an image capturing device at a first device as the user is uttering the text. The images of the facial features of user 1 are analyzed to determine the facial expressions and from which emotions of the user while they are uttering the text. As noted, the emotions determined from the facial expressions of user 1 are verified against the emotions determined from the personal qualities included in the metadata. When the verification is successful, the metadata is generated with the personal qualities identified from the verbal expressions of the audio. When the verification is unsuccessful, additional verification may be initiated, as shown when generating metadata 2. The additional verification may be done by capturing additional images of user 1 and/or performing additional analysis of the verbal expressions determined from the audio. The generated metadata is associated with the text. The metadata and the text are bundled together into data packets and transmitted over the internet to the second device. The analog signal of the audio is thus converted into digital format and transmitted and the audio is reconstructed at the second device using the digital format to generate the analog signal that closely mimics the analog signal of the audio captured at the first device.

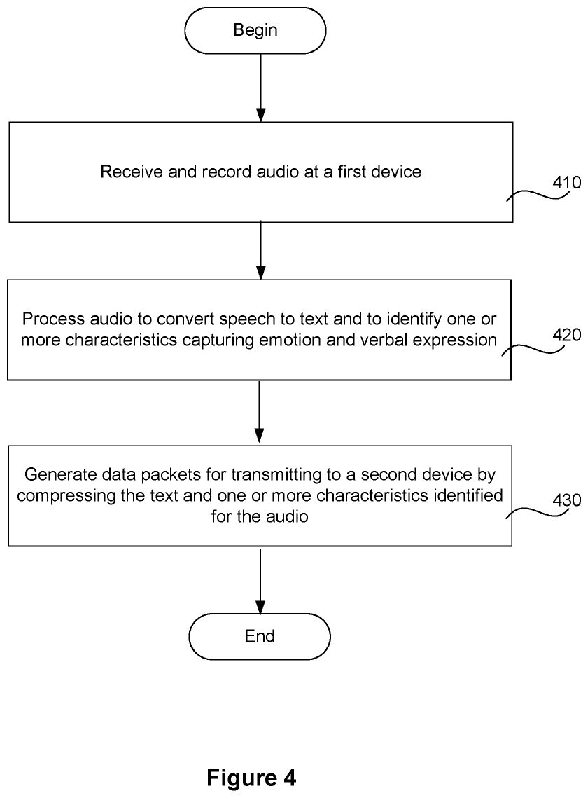

FIG. 4 illustrates a flow of operations of a method for recreating audio, in one implementation. The method begins at operation 410 where the audio generated by a first user is received at a first device. The audio can be received through a microphone or other audio receiving device of the first device. The audio can be a part of communication between a first user and a second user or can be a voice input to an interactive application. The audio is processed to convert speech to text using a speech-to-text engine and analyze the audio signal to identify one or more characteristics capturing emotion and verbal expression, as shown in operation 420. The verbal expression represents the intent of the user and defines the personal qualities of the user, such as tone, pitch, pacing, spacing between words, volume, etc. The one or more characteristics identified from the audio signal can be verified using images of the user captured at the time the user is uttering the text, using an image capturing device. The images of the user capture facial features, which can be analyzed to determine the emotion expressed by the user. The emotion expressed by the user can be verified against the emotion determined from the characteristics of the audio.

Upon successful verification, the text and the characteristics are compressed to generate data packets, as shown in operation 430. The data packets are generated in accordance to communication protocol defined between the first device and a second device to which the data packets are being transmitted. The data packets transmitted to the second device over the internet are decompressed and rendered for a second user's consumption or used as voice input to an interactive application, such as video game, chat application, social media application, etc., wherein the voice input is used to affect a state of the interactive application.

The transmission of the text and the metadata capturing the characteristics of the audio consume less bandwidth as the data that is being sent is digital data as opposed to the analog signal of the audio. The text and the metadata capture the essence of the audio without ambient noise and, when reconstructed, is more legible and understandable and maintains the intimacy and personability as though talking to the user in person.

It should be noted that the first device can be a computing device that is configured to communicate with other computing devices, such as the second device, that are located remotely or are part of a cloud gaming site over a network, which can include local area network (LAN), wide area network, cellular network (e.g., 4G, 5G, etc.,) or any other type of data network, including the Internet and such communication can be through wired or wireless connection.

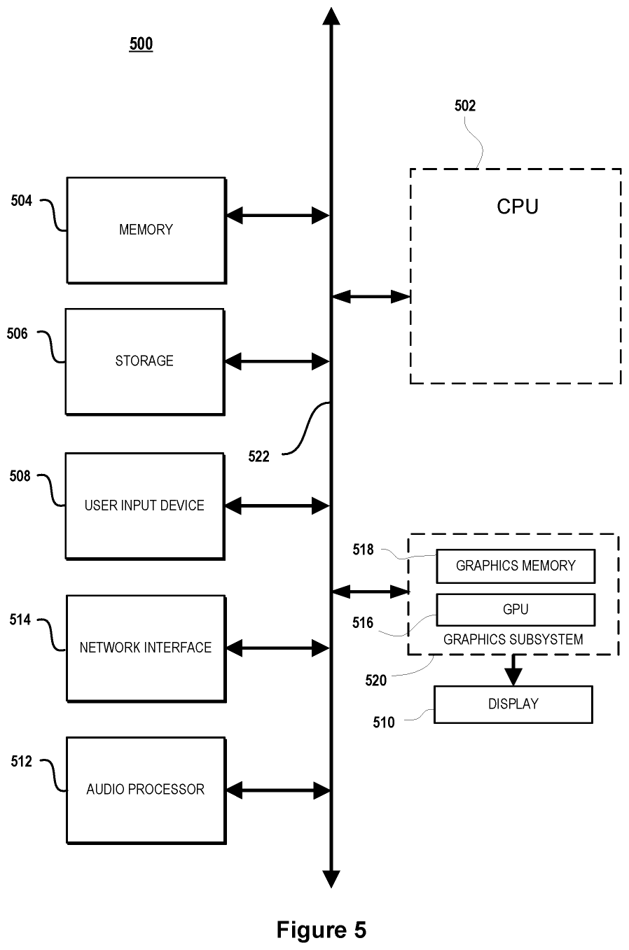

FIG. 5 illustrates components of an example device 500 that can be used to perform aspects of the various embodiments of the present disclosure. This block diagram illustrates a device 500 that can incorporate or can be a personal computer, video game console, personal digital assistant, a head mounted display (HMD), a wearable computing device, a laptop or desktop computing device, a server or any other digital device, suitable for practicing an embodiment of the disclosure. For example, the device 500 represents a first device as well as a second device in various implementations discussed herein. Device 500 includes a central processing unit (CPU) 502 for running software applications and optionally an operating system. CPU 502 may be comprised of one or more homogeneous or heterogeneous processing cores. For example, CPU 502 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 500 may be localized to a player playing a game segment (e.g., game console), or remote from the player (e.g., back-end server processor), or one of many servers using virtualization in a game cloud system for remote streaming of gameplay to client devices.

Memory 504 stores applications and data for use by the CPU 502. Storage 506 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 508 communicate user inputs from one or more users to device 500, examples of which may include keyboards, mice, joysticks, touch pads, touch screens, still or video recorders/cameras, tracking devices for recognizing gestures, and/or microphones. Network interface 514 allows device 500 to communicate with other computer systems via an electronic communications network, and may include wired or wireless communication over local area networks and wide area networks such as the internet. An audio processor 512 is adapted to generate analog or digital audio output from instructions and/or data provided by the CPU 502, memory 504, and/or storage 506. The components of device 500, including CPU 502, memory 504, data storage 506, user input devices 508, network interface 510, and audio processor 512 are connected via one or more data buses 522.

A graphics subsystem 520 is further connected with data bus 522 and the components of the device 500. The graphics subsystem 520 includes a graphics processing unit (GPU) 516 and graphics memory 518. Graphics memory 518 includes a display memory (e.g., a frame buffer) used for storing pixel data for each pixel of an output image. Graphics memory 518 can be integrated in the same device as GPU 516, connected as a separate device with GPU 516, and/or implemented within memory 504. Pixel data can be provided to graphics memory 518 directly from the CPU 502. Alternatively, CPU 502 provides the GPU 516 with data and/or instructions defining the desired output images, from which the GPU 516 generates the pixel data of one or more output images. The data and/or instructions defining the desired output images can be stored in memory 504 and/or graphics memory 518. In an embodiment, the GPU 516 includes 3D rendering capabilities for generating pixel data for output images from instructions and data defining the geometry, lighting, shading, texturing, motion, and/or camera parameters for a scene. The GPU 516 can further include one or more programmable execution units capable of executing shader programs.

The graphics subsystem 520 periodically outputs pixel data for an image from graphics memory 518 to be displayed on display device 510. Display device 510 can be any device capable of displaying visual information in response to a signal from the device 500, including CRT, LCD, plasma, and OLED displays. In addition to display device 510, the pixel data can be projected onto a projection surface. Device 500 can provide the display device 510 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play/replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet.

It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD, the real-world objects, and inertial sensor data from the Inertial Motion Unit (IMU) sensors, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

As noted, embodiments of the present disclosure for communicating between computing devices may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A method for recreating audio, comprising:
recording an audio generated by a user at a first device;
processing the audio of the user to convert speech to text and to identify one or more characteristics capturing emotion and verbal expression of the user, the one or more characteristics defining metadata of the audio; and
generating data packets by compressing the text and the metadata of the audio for transmission over a network to a second device that is remotely located from the first device, the text and the metadata included in the data packets used to re-create the audio at the second device for rendering, the re-created audio replicating the emotion and verbal expressions expressed by the user at the first device.

2. The method of claim 1, wherein the processing of the audio includes,
interpreting the audio in accordance to a language spoken in the audio to identify the one or more characteristics of the audio, each language having specific interpretations for identifying the one or more characteristics capturing the emotion and the verbal expressions expressed by the user.

3. The method of claim 1, wherein the processing of the audio further includes,
verifying the emotion and the verbal expressions identified from the audio against facial expressions of the user while generating the audio, the facial expressions captured by an image capturing device that is coupled to the first device.

4. The method of claim 1, wherein each of the one or more characteristics are tunable to define personal preferences of the user, the personal preferences defined to be specific for the user, for a language used in the audio, or for an interactive application.

5. The method of claim 4, wherein the processing of the audio further includes,
receiving adjustment to the one or more characteristics, in accordance to the personal preferences of the user;
applying the adjustment to corresponding one or more characteristics identified from the audio, the adjustment capturing the emotion and the verbal expressions desired by the user; and
saving the one or more characteristics with the applied adjustment alongside corresponding text identified for the audio, the one or more characteristics with the applied adjustment and the text transmitted as data packets to the second device for rendering.

6. The method of claim 1, wherein the one or more characteristics defining the metadata include any one or a combination of tone of speech, pitch, spacing of words uttered, and volume, the one or more characteristics defining a voice fingerprint capturing the emotion and the verbal expressions of the user.

7. The method of claim 1, wherein the first device is a first laptop computing device or a first mobile computing device, and wherein the second device is a server computing device or a cloud server computing device or a game console or a second laptop computing device or a second mobile computing device.

8. The method of claim 1, wherein the audio is processed to convert analog signal to digital data by converting speech of the audio to text and identifying the one or more characteristics defining finger print of the audio, and wherein the data packets with the text and the metadata of the audio are transmitted to the second device in a digital format.

9. A system for recreating audio, comprising:
a first device used to capture audio spoken of a user, the first device coupled to a first codec, the first codec configured to,
record the audio of the user captured at the first device;
process the audio to convert speech to text and to identify one or more characteristics capturing emotion and verbal expressions of the user captured in the audio, the one or more characteristics define metadata of the audio; and
generating data packets using the text and the metadata identified for the audio, the data packets generated by compressing the text and the metadata of the audio for transmission to a second device for rendering, wherein the second device is located remotely from the first device,
the second device coupled to a second codec, the second codec configured to decompress the data packets to extract the text and the metadata included therein, the text and the metadata used to re-create the audio of the user at the second device, the re-created audio replicating the emotion and the verbal expressions of the user captured in the audio at the first device.

10. The system of claim 9, wherein the first codec is integrated within the first device, and the second codec is integrated within the second device.

11. The system of claim 9, wherein the first codec is communicatively coupled to and is independent of the first device, and the second codec is communicatively coupled to and is independent of the second device.

12. The system of claim 9, wherein the first device is a first laptop computing device or first a desktop computing device or a first mobile computing device, and
wherein the second device is a server computing device or a cloud server computing device or a game console or a second laptop computing device or a second mobile computing device or a second desktop computing device.

13. The system of claim 9, wherein the first codec includes a language interpreter configured to interpret the audio captured at the first device, in accordance to a language spoken in the audio to identify the one or more characteristics of the audio, the one or more characteristics capturing the emotion and the verbal expressions expressed by the user in the language.

14. The system of claim 9, wherein the first device is coupled to an image capturing device and configured to receive image of the user captured by the image capturing device as the user is generating the audio, the image of the user associated with a corresponding portion of the audio, the image of the user forwarded by the first device to the first codec for verifying facial expressions of the user against the emotion and the verbal expressions identified for the corresponding portion of the audio.

15. The system of claim 9, wherein the first codec includes one or more tunable digital knobs for tuning one or more characteristics of the audio to define personal preferences of the user, wherein the first codec is configured to process the audio in accordance to the personal preferences of the user.

16. The system of claim 15, wherein the one or more tunable digital knobs are configured to be controlled by a user, by an interactive application, or is tuned for a language used in the audio.
